(19) United States
(12) Patent Application Publication
(10) Pub. No.: US 2005/0235654 A1
(43) Pub. Date: Oct. 27, 2005

(54) Evaporator arrangement for generating a hydrocarbon vapor/mixed material mixture, especially for a reformer arrangement of a fuel cell system

(76) Inventors: Andreas Kaupert, Esslingen (DE); Gunter Eberspach, Wolfschlugen (DE); Walter Blaschke, Deizisau (DE); Andreas Collmer, Aichwald (DE); Karsten Reiners, Stuttgart (DE); Lutz Hartmann, Schwabhausen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/113,893

(22) Filed: Apr. 25, 2005

(30) Foreign Application Priority Data
Apr. 26, 2004 (DE) 10 2004 020 507.8

(51) Int. Cl. F17C 9/02; F25B 41/00

(52) U.S. Cl. 62/50.2

(57) ABSTRACT

An evaporator arrangement and/or vaporizing burner is provided for generating a hydrocarbon vapor/mixed material mixture. The arrangement has a mixing chamber (50) surrounded by a circumferential wall area (46) and a bottom wall area (44). Inlet openings (48) are provided in the circumferential wall area (46) for the entry of gaseous mixed material into the mixing chamber (50) and the bottom wall area (44) has a porous evaporator medium (62) for absorbing liquid hydrocarbon. A first heating device (76) is associated with the porous evaporator medium (62). A second heating device (94) heats the mixed material before or/and during its passage through the inlet openings (48).

### CROSS REFERENCE TO RELATED APPLICATIONS

This application claims the benefit of priority under 35 U.S.C. § 119 of German Application DE 10 2004 020 507.8 filed Apr. 26, 2004, the entire contents of which are incorporated herein by reference.

### FIELD OF THE INVENTION

The present invention pertains to an evaporator arrangement for generating a hydrocarbon vapor/mixed material mixture.

### BACKGROUND OF THE INVENTION

A hydrocarbon vapor/mixed material mixture can be converted, for example, in a reformer arrangement of a fuel cell system in order to generate a hydrogen-containing gas therefrom, or in an internal combustion engine with exhaust gas cleaning or exhaust gas cooling. This hydrogen-containing gas can be reacted in a fuel cell of such a fuel cell system together with atmospheric oxygen in order to generate electricity. Especially during the start phase of such evaporator arrangements and fuel cell systems, there is a problem that comparatively high temperatures are needed in different areas of the system to make it possible to start the catalytic reactions necessary for the conversion. A corresponding catalytic reaction can take place only conditionally and with comparatively poor quality until such temperatures are reached.

### SUMMARY OF THE INVENTION

The goal of the present invention is to provide an evaporator arrangement for generating a hydrocarbon vapor/mixed material mixture, which mixture can be brought more rapidly into a state necessary for the desired operation and can be maintained in such a state in an improved manner.

According to one aspect of the present invention, this object is accomplished by an evaporator arrangement for generating a hydrocarbon vapor/mixed material mixture, comprising a mixing chamber, which is surrounded by a circumferential wall area and a bottom wall area, wherein inlet openings for the entry of gaseous mixed material into the mixing chamber are provided in the circumferential wall area, and the bottom wall area has a porous evaporator medium for receiving liquid hydrocarbon and, associated with the porous evaporator medium, a first heating means, characterized by a second heating means for heating the mixed material before or/and during the passage through the inlet openings.

Consequently, it is not only the initially still liquid hydrocarbon vapor that is heated in the evaporator arrangement according to the present invention, which is necessary per se in order to cause its evaporation in the first place. The mixed material to be mixed with the hydrocarbon vapor, i.e., for example, air, steam, burner waste gas, fuel cell waste gas, exhaust gas of an internal combustion engine or the like, is consequently also heated before being mixed with the hydrocarbon vapor. The consequence of this is that the mixture, which is then to be used further, can be provided with a markedly higher temperature, so that the reactions that are to be subsequently carried out, for example, the catalytic generation of hydrogen, can start sooner or can take place with improved quality.

For example, the second heating means may be provided at the circumferential wall area. It is especially advantageous here for design reasons for the second heating means to be arranged in such a way that it surrounds the circumferential wall area.

The activation of the second heating means can then be carried out in an especially simple manner when this comprises an electrically energizable heat conductor.

Provisions may, furthermore, be made for the second heating means to comprise a heat exchanger area located upstream of the inlet openings in the direction of flow of the mixed material. Especially if the evaporator arrangement according to the present invention is combined with a fuel cell system, the heat exchanger area can then comprise as the heat source a reformer area, which is located downstream of the mixing chamber in the direction of flow and contains catalytic material, i.e., the heat generated during the catalytic generation of hydrogen can be utilized to preheat the mixed material or part of the mixed material before it is introduced into the heating chamber. This contributes to the improved quality of the conversion taking place.

According to another aspect of the present invention, provisions may be made for at least one hydrocarbon line to be provided for sending liquid hydrocarbon to the porous evaporator medium and for a discharge end area of the at least one hydrocarbon line to be maintained under pressure against the porous evaporator medium.

By firmly pushing or pressing the at least one hydrocarbon line against the porous evaporator medium, it is ensured that the total amount of liquid hydrocarbon being delivered via this line will also enter the volume area of the porous evaporator medium and can be distributed in it. The consequence of this is the improved and more uniform introduction and distribution of the liquid hydrocarbon in this evaporator medium with a correspondingly more uniform evaporation and consequently also with improved mixture formation.

The reliable and essentially complete introduction of the liquid hydrocarbon into the volume area of the porous evaporator medium can be additionally supported by the at least one hydrocarbon line having a cutting edge-like edge area pressed against the porous evaporator medium in its discharge end area.

If provisions are made, furthermore, for the at least one hydrocarbon line to be heat-insulated in or/and near its discharge end area, there is no risk that the liquid hydrocarbon will begin to evaporate due to thermal effects of the liquid hydrocarbon already before the discharge from the line carrying same and compromising the distribution characteristic in the porous evaporator medium in the process.

Provisions may be made for this purpose, for example, for the at least one hydrocarbon line to have a double-walled design in or/and near its discharge end area. It can thus be ensured that, for example, the mixed material, which flows around the line in some areas and is already preheated, cannot come into direct contact with the area of the line that carries the liquid hydrocarbon.

Furthermore, the most uniform distribution possible of the liquid hydrocarbon in the porous evaporator medium can also be supported, when considering the force of gravity, which also contributes to the distribution, by the at least one hydrocarbon line opening, in relation to the central longitudinal axis of the mixing chamber, eccentrically into the porous evaporator medium.

According to another aspect of the present invention, provisions may be made for a heat conduction element to be arranged on a side of the porous evaporator medium facing away from the mixing chamber between the porous evaporator medium and the first heating means. It is ensured by positioning a heat conduction element between the porous evaporator medium and the first heating means that the heat made available in the first heating means will be introduced into the porous evaporator medium not only locally but also in the most uniformly distributed form possible, and the most uniform evaporation possible is thus supported.

Provisions may be made in this connection, for example, for the heat conduction element to comprise a heat conduction plate, preferably one of a shell shape.

According to another aspect of the present invention, provisions may be made for providing at least two catalyst arrangements arranged one after another in the direction of flow in a reformer area arranged downstream of the mixing chamber in the direction of flow. By making available a plurality of catalyst arrangements arranged one after another, the efficiency can be increased during the conversion of the mixture generated in the mixing chamber into a hydrogen-containing gas.

To ensure in the process that a sufficient amount of heat remains stored in that catalyst arrangement or in those catalyst arrangements in which reactions take place with a less strongly exothermal character to make it possible to carry out this conversion, it is proposed that at least one of the catalyst arrangements be secured more strongly against the release of heat than at least one other of the catalyst arrangements. Due to the stronger shielding against the release of heat, an increased amount of heat will then be maintained in this local area.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a partial longitudinal sectional view of an evaporator arrangement according to the present invention in conjunction with a reformer area;

FIG. 2 is a perspective view of the area of the evaporator arrangement according to FIG. 1 which has a first heating means;

FIG. 3 is a sectional view, which represents the cooperation of a hydrocarbon line with a porous evaporator medium;

FIG. 4 is a view of a modified embodiment variant corresponding to FIG. 3; and

FIG. 5 is another view of a modified embodiment variant corresponding to FIG. 3.

### DESCRIPTION OF THE PREFERRED EMBODIMENTS

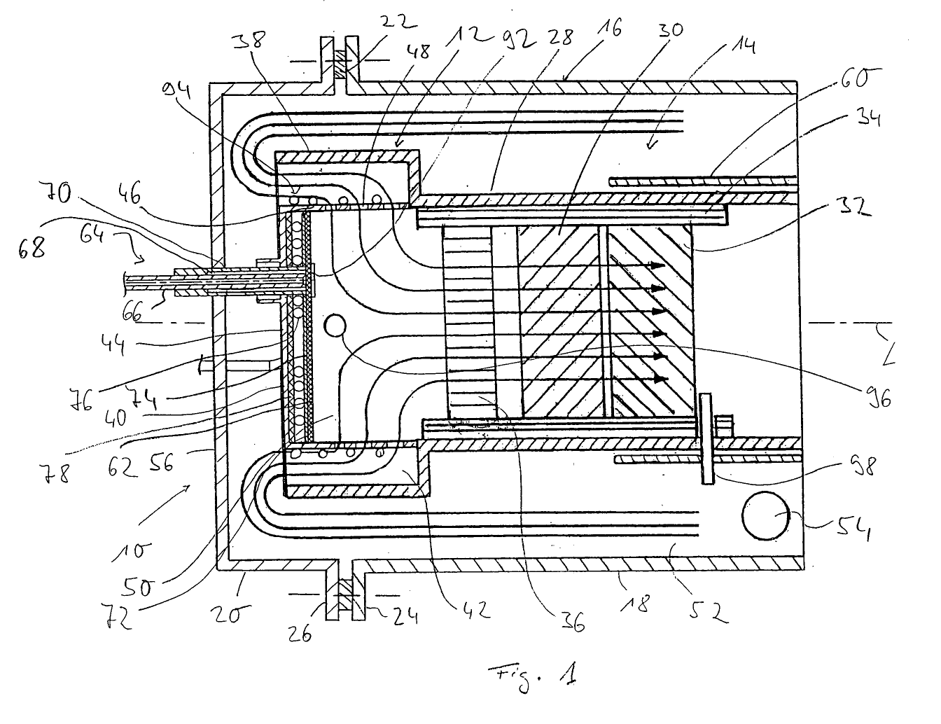

Referring to the drawings in particular, FIG. 1 shows an area of a fuel cell system, which is used, for example, in a motor vehicle. This area 10, generally designated as an evaporator arrangement, comprises an evaporator area 12, in which a mixture of evaporated hydrocarbon and gaseous mixed material is made available, and it comprises, furthermore, a reformer area, which is generally designated by 14 and in which the mixture made available in the evaporator area 12 is converted by catalytic reaction in order to generate a hydrogen-containing gas that can be used in a fuel cell.

The evaporator arrangement 10 is generally accommodated in a housing 16, which comprises, for example, two housing parts 18, 20. The two housing parts 18, 20 are connected with one another in a gas-tight and detachable manner, for example, through the interposition of a sealing material 22, for example, by a multiple screw connection in radially outwardly extending flange areas 24, 26 or by a tensioning element. The point of separation between the two housing parts 18, 20 is preferably positioned such that by removing one of the housing parts, for example, the housing part 20, access can be obtained to system areas that are possibly relevant for repair or maintenance operations, e.g., the evaporator area 12. An additional, inner housing 28 is arranged in the housing 16. This tubularly shaped inner housing 28 carries in the reformer area 14 the catalyst arrangements 30, 32, which will be described below. These may be held at the inner housing 28, for example, via an elastic, vibration-damping material 34. This contributes to the protection of the catalyst arrangement 30, 32 against the vibrations that are generally present in motor vehicles and possibly compromise the functionality of the catalyst arrangement 30, 32. This elastic material 34 is preferably also gas-tight, so that flow around the catalyst arrangements 30, 32 at their outer areas is not possible and the entire mixture flow must pass through this catalyst arrangement 30, 32.

A flame retention baffle 36 is positioned upstream of the catalyst arrangements 30, 32 in the direction of flow of the gas or mixture flow. Farther upstream the inner housing 28 has an area 38 that is radially expanded in relation to its central longitudinal axis L. This [area] limits, with an essentially pot-shaped mixing chamber housing 40, an annular intake space 42. This mixing chamber housing 40 has a bottom wall area 44 and a circumferential wall area 46, which adjoins, for example, the radially smaller area of the inner housing 28 and is thus firmly connected. It shall be pointed out here that the bottom wall area 40 and the circumferential wall area 46 or a part of the latter can, of course, be provided as separate assembly units, but they may, of course, also be designed as integral parts, as this is shown in FIG. 1.

A plurality of inlet openings 48, which provide a connection between the space 42 mentioned and a mixing chamber 50 formed in the mixing chamber housing 40, are formed in the circumferential wall area 46. The gas to be used to form the mixture, i.e., for example, air, enters the interior space of the housing 16, i.e., essentially a volume area 52 formed between the inner housing 28 and the housing part 18, via one or more openings 54. The air then flows, for example, under the delivery action of a blower, not shown, in the direction of the housing part 20, is deflected at a bottom area 56 thereof—axially again in relation to the central longitudinal axis L—and enters the annular space area 42. Via the inlet openings 48, this mixed material enters the mixing chamber 50. It is recognized that during this flow, the mixed material flows around an enlarged circumferential area of the inner housing 28 in the area in which the inner housing 28 is radially expanded to form the section 38, as a consequence of which intensified heat transfer to the inner housing 28 can take place here in the case in which this mixed material is already preheated.

To ensure good mixing with the hydrocarbon vapor, which is likewise present in the mixing chamber 50, during the entry of the mixed material into the mixing chamber 50, deflecting elements, which ensure that the mixed material forms a tangential flow during its entry into the mixing chamber 50, i.e., that it enters tangentially into the mixing chamber, may be present, for example, in the space area 42. Such deflecting elements or swirl generators may, of course, also be positioned in the area of the mixing chamber 50 itself.

During a catalytic reaction taking place in the reformer area 14, this mixed material can absorb heat during its flow along the volume area 52 in the section of the inner housing 28 that surrounds and partly also provides the reformer area 14. It is recognized that the mixed material can come into direct contact with the inner housing 28 especially in the area in which the upstream catalyst arrangement 30 is positioned and can thus absorb heat, which is generated in the catalyst arrangement 30 and is transferred to the inner housing 28 via the elastic material 34. The reformer area 14 consequently provides a heat exchanger arrangement or heating means especially with its section around which the mixed material can flow very easily and well in the area of the catalyst arrangement 30. However, it is recognized that the section of the reformer area 14 in which the catalyst arrangement 32 is arranged is surrounded by an, e.g., cylindrical insulation element 60. Consequently, the flow of the mixed material around the inner housing 28 is made more difficult here, on the one hand, and, on the other hand, this insulation element 60 may be designed as a radiation reflector element, i.e., for example, a radiation plate, which ensures that the heat generated in the area of the catalyst arrangement 32, especially radiant heat, is held or reflected increasingly in this area. It can thus be ensured that, for example, in the case in which only a secondary reaction of the components not yet reacted in the catalyst arrangement 30 will take place in the catalyst arrangement 32 under weakly exothermal conditions, less heat will also be released there in order to allow the reaction to take place with improved quality in this catalyst arrangement 32. A corresponding advantage also arises, for example, when different catalytic materials are used for the two catalyst arrangements 30 and 32, and the catalytic material used in the catalyst arrangement 32 is designed for a reaction of a less exothermal character and thus with a greater need to hold heat.

Furthermore, the functionality of the reformer area 14 can also be ensured by providing a plurality of catalyst arrangements for the case in which one of these catalyst arrangements is damaged.

To make available the hydrocarbon vapor already mentioned to generate a mixture, a porous evaporator medium 62, which covers the bottom wall 44, for example, completely, is provided at the bottom wall 44 or in the area of the bottom wall 44 of the mixing chamber housing 40. This porous evaporator medium 62, which consists of a braiding, knitted fabric, foamed ceramic or the like, takes up the generally liquid hydrocarbon from a hydrocarbon line 64.

This line has a double-walled design in the area in which it passes through the housing 16, namely, the housing part 20, and enters the mixing chamber housing 40, with an inner pipe section 66 and an outer pipe section 70 surrounding same in such a way as to form an air gap 68. The hydrocarbon line 64 is thus heat insulated in the area in which the already preheated mixed material can, in principle, also flow around it. The risk that evaporation of the hydrocarbon will take place already in the hydrocarbon line itself can thus be eliminated.

The hydrocarbon line 64 extends to the rear side 72 of the porous evaporator medium 62 located such that this rear side faces away from the mixing chamber 50. Furthermore, a heat distribution plate 74, e.g., one made of a metallic material, which preferably covers this porous evaporator medium over its full area with the exception of the area in which the hydrocarbon line 64 extends to it, is located at the rear side 72 of the porous evaporator medium 62. On the side of this heat distribution plate 74 facing away from the porous evaporator medium 62, there is a first heating means 76 designed as an electrically energizable heating coil. An insulating element 78 designed, for example, as a nonwoven, may be positioned between the bottom wall area 44 and this first heating means 76 in order to prevent heat transfer from the first heating means 76 to the bottom wall 64 to the extent possible and thus to transfer the heat made available in the first heating means 76 to the evaporator medium 62 over the full area and uniformly and efficiently as much as possible, also utilizing the good thermal conductivity of the heat distribution plate 74. Provisions are preferably also made for this purpose for this first heating means 76, which can also be recognized in FIG. 2 and which may be designed, for example, in the manner of a heating coil, to be able to admit heat to the largest possible area of the porous evaporator medium 62 and the heat distribution plate 74. The heat distribution plate 74 may also be designed in the form of a shell. In this case, it also surrounds the evaporator medium at the outer edge area and thus prevents the escape of liquid not only on the rear side, but also in the outer area of the evaporator medium.

FIG. 3 shows the interaction between the hydrocarbon line 64 and the porous evaporator medium 62. Only the inner pipe section 66 is shown here. It is obvious that the outer pipe section 70 could also be provided in the manner shown in FIG. 1.

It is recognized that the hydrocarbon line 64 and the inner pipe section 66 are provided with a cutting edge-like edge area 82 in a discharge end area 80 and engage a recess 84 formed on the rear side of the porous evaporator medium 62. The hydrocarbon line 64 is pressed with this cutting edge-like edge area 82 against the porous evaporator medium 62. This ensures that the liquid hydrocarbon being discharged from the hydrocarbon line 64 can completely enter the volume area of the porous evaporator medium 62 and can be distributed there, and that there is no risk that parts of the liquid hydrocarbon will drop off and accumulate in some areas of the mixing chamber housing 40. This risk is present especially during heating and specifically in case of a possible arching of the evaporator medium. The fact that the contact between the hydrocarbon line 64 and the porous evaporator medium 62 takes place in the recess 84 contributes to this as well. Even if liquid hydrocarbon dropped down under the most unfavorable conditions, it would be absorbed by the material area of the porous evaporator medium 62 surrounding the recess 84.

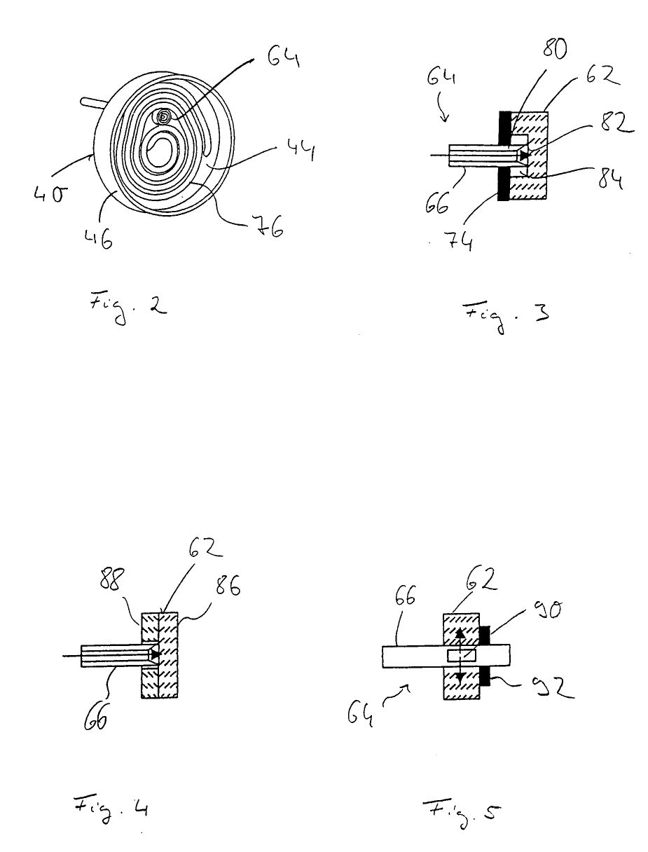

FIG. 4 shows an alternative embodiment of the porous evaporator medium 62 comprising two layers 86, 88. These may be optimized, for example, in respect to the respective special requirements. Thus, the layer 86 may be optimized concerning the release of hydrocarbon by evaporation, while the layer 88 may be optimized concerning the absorption of heat from the heat distribution plate 74 and the uptake of hydrocarbon.

FIG. 5 shows a variant in which the line section 66 of the hydrocarbon line 64 passes completely through the porous evaporator medium 62, designed either in the form of one layer or in the form of two layers. It exits on the side of the porous evaporator medium 62 facing the mixing chamber 50 and is closed off there. In the section that is in the thickness range of the porous evaporator medium 62, the pipe section 66 has one or more openings 90, through which the hydrocarbon is then discharged from the line 64 and enters the volume area of the porous evaporator medium 62. The risk that the hydrocarbon is discharged from the line 64 without entering the porous evaporator medium 62 is practically absent here as well.

As can be recognized from FIGS. 1 and 5, the porous evaporator medium may be covered by a deflecting element 92 on its side facing the mixing chamber 50 in the area in which the hydrocarbon line 64 delivers liquid hydrocarbon into it. This [deflecting element] ensures that a radial distribution will inevitably take place in relation to the line 64 in the immediate area in which the hydrocarbon enters, without increased discharge of hydrocarbon vapor from the porous evaporator medium 62 being able to be generated there. The distribution of the liquid hydrocarbon in the porous evaporator medium and the homogenization of the evaporation can thus be supported.

The fact that the heat conduction plate 74 is kept ready on the rear side of the porous evaporator medium 62 likewise offers the advantage that no hydrocarbon vapor can be discharged from the porous evaporator medium 62 on this side, which is heated in an intensified manner by the first heating means 76.

Furthermore, the fact that the hydrocarbon line 64 opens eccentrically in relation to the central longitudinal axis L, which also forms, in principle, the central longitudinal axis of the mixing chamber 50, also ensures the homogenization of the evaporation. If the evaporator arrangement 10 is installed in the situation shown in FIG. 1, the fact that a force of gravity component is also superimposed to the distribution of the liquid hydrocarbon in the porous evaporator medium 62 by the action of capillary forces is also increasingly taken into account by this upwardly displaced introduction of the liquid hydrocarbon.

The keeping ready of the heat conduction plate 74 on the rear side of the porous evaporator medium 62 has, furthermore, the advantage that no hydrocarbon vapor can be discharged from the porous evaporator medium 62 on this side, which is heated in an intensified manner by the first heating means 76.

The homogenization of the hydrocarbon distribution in the porous evaporator medium 62 can, furthermore, also be supported by the fact that a plurality of hydrocarbon lines 64 introduce liquid hydrocarbon into the porous evaporator medium 62 at different areas.

It is, of course, possible that the heat conductor of the first heating means 76 can also be in direct contact with the porous evaporator medium. It may be advantageous in this case to firmly connect components of this porous evaporator medium with the heat conductor already at the time of the manufacture of the heat conductor, for example, by fine metal wires being pressed against same, if the porous evaporator medium is designed, for example, as a nonwoven metal material.

It is also recognized from FIG. 1 that the circumferential wall 64 of the mixing chamber housing 40 is surrounded by a second heating means 94 designed, for example, as a heating coil. This second heating means 94, which can be activated, just like the first heating means 76, by electric energization, ensures that, on the one hand, the circumferential wall 46 is preheated and the temperature in the mixing chamber 50 is thus also increased. On the other hand, this second heating means 94 transfers heat to the gaseous mixed material flowing through the space area 42, so that the mixed material entering the mixing chamber 50 can thus also be preheated, for example, during a phase of the operation in which no or only little heat can be provided in the catalyst area 14 because no catalytic reaction is still taking place. This preheated mixed material can then be mixed in the likewise already preheated mixing chamber 50 with the likewise preheated fuel vapor and thus preheat the reformer area 14 and the catalyst arrangement 30, 32 thereof during its further flow in the direction of the reformer area 14.

To heat the reformer area 14 during the start phase, it is also possible to follow the procedure in the case of the evaporator arrangement 10 according to the present invention that the two heating means 76, 94 are first activated during a start phase and a comparatively warm mixture of hydrocarbon vapor and mixed material is thus made available. This mixture can then be ignited by activating an igniting member, for example, a glow-type ignition pin 96 and thus burned in the mixing chamber 50. The flame retention baffle 36 ensures during this phase that the combustion is maintained in the mixing chamber 50 and cannot lead to damage to the downstream catalyst arrangement 30. The very hot combustion products generated during this combustion pass through the flame retention baffle 36 and the catalyst arrangements 30, 32 and thus ensure the heating of the reformer area 32 in a very short time. If a predetermined time has passed since the start of the combustion or/and there is a sufficiently high temperature in the relevant system areas, for example, the reformer area, which can be recognized, for example, by a temperature sensor 98, the combustion can be stopped, for example, by briefly interrupting the feed of mixed material or/and hydrocarbon. After the termination of the combustion, the feed of mixed material and hydrocarbon can be resumed in order to make it then possible to make available the mixture which is to be converted into hydrogen-containing gas in the reformer arrangement 14. Since the mixed material flowing through the volume area 52 can already take up a sufficient amount of heat, for example, from the reformer area 14 during this phase, the activation of the second heating means 94 or/and of the first heating means 76 may possibly be terminated as a function of the prevailing ambient temperatures. However, since combustion, which could generate very high temperatures in the mixing chamber 50, will not take place in the mixing chamber 50 during this phase of operation, it is advantageous to continue to operate at least the first heating means 76 during this phase to support the evaporation of the fuel.

It shall be pointed out that the mixed material can, of course, also take up heat in the area of other or additional heat exchanger arrangements. For example, heat can be transferred to the mixed material by the comparatively warm gas leaving the reformer area 14 in the flow area that is located downstream of the catalyst arrangements 30, 32 and leads, for example, in the direction of a fuel cell. Heat is also generated in the area of a fuel cell itself during the operation of the fuel cell, and this heat can be utilized to preheat the mixed material. Corresponding statements can also be made concerning a gas purification stage, which may be positioned between the reformer area 14 and the fuel cell. Since it is not possible, in general, to react the total amount of hydrogen with atmospheric oxygen during the operation of the fuel cell and a gas still containing residual hydrogen leaves the fuel cell, afterburning can take place in a so-called anode waste gas burner. The heat made available during the afterburning can then be transferred at least partly to the mixed material to be introduced into the mixing chamber 50.

The system described above in reference to FIGS. 1 through 5 combines various measures that are especially advantageous for the operation. Thus, on the one hand, preheating of the device itself is achieved by the preheating of the mixed material, for example, by the second heating means 94, and, on the other hand, it is also possible to introduce the mixed material already with elevated temperature into the reformer area 14. It is ensured by designing the system areas that contribute to the evaporation of the hydrocarbon or fuel, especially also the hydrocarbon line and the first heating means 76, that this mixed material introduced in the heated state into the reformer area 14 is mixed highly uniformly with hydrocarbon vapor. Due to the special design of the reformer area, it is, furthermore, ensured that, on the one hand, the catalytic reaction can take place there with the desired quality, but, on the other hand, the other catalyst arrangement or the other catalyst arrangements, if additional catalyst arrangements are also provided, can completely assume this function even if problems develop in the area of one of the catalyst arrangements.

It should be taken into consideration during the operation of such a reformer area 14 that the oxygen contained in the mixed material, i.e., for example, atmospheric oxygen, does, in principle, prolong the service life of the catalytic material of the catalyst arrangements 30, 32, but it also leads at the same time to intensified soot formation. By adding steam or process waste gas, for example, the burner waste gas mentioned above or optionally also hydrogen-containing fuel cell waste gas, it becomes possible to allow the catalytic process taking place in the reformer area 14 to take place with suppressed soot formation, and it is also ensured at the same time that the material of the catalyst arrangements 30, 32 does not become too hot. This addition or admixing of hydrogen-containing mixed material components, for example, to the air, which likewise provides part of the mixed material, is preferably carried out at temperatures above the dew point in order to thus prevent the condensation of the steam being transported. Burner waste gases or fuel cell waste gases may be added to the mixed material already before the reformer area, i.e., for example, at or before the entry into the volume area 52. As an alternative, it is also possible here to add these additional mixed material components only after the mixing chamber 50, i.e., for example, between the flame retention baffle 36 and the upstream catalyst arrangement or even before the flame retention baffle 36. Furthermore, it is possible to draw in such additional mixed material components, i.e., for example. anode burner waste gases or fuel cell waste gases, through an air delivery unit, i.e., a blower, which is used, in general, to deliver mixed material to be introduced into the mixing chamber 50 in advance.

To increase the safety of the overall system, provisions may be made for the evaporator arrangement 10 shown in FIG. 1 to be arranged above the interior space of the vehicle or/and in another gas-tight container. A gas sensor may be provided in this gas-tight container in order to make it possible to generate a corresponding warning when the escape of gas, especially hydrogen-containing gas, is detected. Furthermore, it is self-explanatory that this container or the arrangement shown in FIG. 1 can likewise be mounted in a shock-absorbed manner, for example, on springs or rubber buffers, in order to make it possible to prevent damage that may possibly be caused by vibrations. The material leaving the reformer area 14, which is enriched with hydrogen and therefore has a very high explosion hazard, can be delivered in the direction of a fuel cell or a corresponding tank via a line, which is, of course, gas-tight and explosion-proof.

Finally, it shall be pointed out that any hydrocarbon that is suitable, for example, for generating hydrogen-containing gas is suitable for use as a hydrocarbon to be evaporated. In particular, it is also possible to use fuels generally intended for use in a motor vehicle, e.g., diesel fuel, biodiesel or gasoline, for this purpose. Furthermore, it shall be pointed out that, in particular, the aspects of the present invention that were described above in reference to the evaporator area 12 may be provided not only in conjunction with a reformer area. Such an evaporator area may, of course, rather also be used in a burner of a heater as it is used, for example, as a parking heater or auxiliary heater in a vehicle.

While specific embodiments of the invention have been shown and described in detail to illustrate the application of the principles of the invention, it will be understood that the invention may be embodied otherwise without departing from such principles.

1. An evaporator arrangement for generating a hydrocarbon vapor/mixed material mixture, comprising, the evaporator comprising:
a circumferential wall area and a bottom wall area defining a mixing chamber with inlet openings in said circumferential wall area for the entry of gaseous mixed material into said mixing chamber
a porous evaporator medium for absorbing liquid hydrocarbon, said bottom wall area having said porous evaporator medium;
a first heating means associated with said porous evaporator medium for heating in a region of said porous evaporator medium;
a second heating means for heating said mixed material before or/and during the passage through said inlet openings.

2. An evaporator arrangement in accordance with claim 1, wherein said second heating means is provided at said circumferential wall area.

3. An evaporator arrangement in accordance with claim 2, wherein said second heating means is arranged such that it surrounds said circumferential wall area.

4. An evaporator arrangement in accordance with claim 2, wherein said second heating means comprises an electrically energizable heat conductor.

5. An evaporator arrangement in accordance with claim 1, wherein said second heating means comprises a heat exchanger area located upstream of said inlet openings in the direction of flow of the mixed material.

6. An evaporator arrangement in accordance with claim 5, wherein said heat exchanger area comprises as a heat source a reformer area, which is arranged downstream of said mixing chamber in the direction of flow and contains catalytic material.

7. An evaporator arrangement in accordance with claim 1, further comprising a hydrocarbon line provided for sending liquid hydrocarbon to said porous evaporator medium and said hydrocarbon line having a discharge end area maintained under pressure against said porous evaporator medium.

8. An evaporator arrangement in accordance with claim 7, wherein said hydrocarbon line has a cutting edge-like edge area that is pressed against said porous evaporator medium in said discharge end area.

9. An evaporator arrangement in accordance with claim 8, wherein said hydrocarbon line has heat insulation in or/and near said discharge end area.

10. An evaporator arrangement in accordance with claim 9, wherein said hydrocarbon line is designed as a double-walled line in or/and near its said discharge end area.

11. An evaporator arrangement in accordance with claim 7, wherein said hydrocarbon line opens eccentrically into said porous evaporator medium relative to a central longitudinal axis of said mixing chamber.

12. An evaporator arrangement in accordance with claim 1, further comprising a heat conduction element arranged on a side of said porous evaporator medium facing away from said mixing chamber between said porous evaporator medium and said first heating means.

13. An evaporator arrangement in accordance with claim 12, wherein said heat conduction element comprises a heat conduction plate.

14. An evaporator arrangement in accordance with claim 1, further comprising two catalyst arrangements that follow each other in the direction of flow provided in a reformer area arranged downstream of said mixing chamber in the direction of flow.

15. An evaporator arrangement in accordance with claim 14, wherein at least one of said two catalyst arrangements is secured against the release of heat more strongly than another of said two catalyst arrangements.

16. A vaporizing burner for generating a hydrocarbon vapor/mixed material mixture, comprising, the vaporizing burner comprising:
a circumferential wall area and a bottom wall area defining a mixing chamber with inlet openings in said circumferential wall area for the entry of gaseous mixed material into said mixing chamber;
a porous evaporator medium for absorbing liquid hydrocarbon, said bottom wall area having said porous evaporator medium;
a first heating means associated with said porous evaporator medium for heating in a region of said porous evaporator medium;
a second heating means for heating said mixed material before or/and during the passage through said inlet openings.

17. A vaporizing burner in accordance with claim 16, wherein said second heating means is provided at said circumferential wall area or arranged such that it surrounds said circumferential wall area.

18. A vaporizing burner in accordance with claim 16, further comprising an ignitor for igniting the mixture for combustion within the mixing chamber.

19. A vaporizing burner in accordance with claim 18, further comprising a hydrocarbon line provided for sending liquid hydrocarbon to said porous evaporator medium and said hydrocarbon line having a discharge end area maintained under pressure against said porous evaporator medium.

20. A vaporizing burner in accordance with claim 18, wherein further comprising two catalyst arrangements that follow each other in the direction of flow provided in a reformer area arranged downstream of said mixing chamber in the direction of flow.
